(19) United States
(12) Patent Application Publication
(10) Pub. No.: US 2011/0011230 A1
(43) Pub. Date: Jan. 20, 2011

(54) DEVICE FOR PRODUCING A HOLE IN A SHEET-SHAPED MATERIAL

(76) Inventors: Nikolaus Bernhard Bergander, Rottweil (DE); Klaus-Peter Paulat, Schwendi (DE)

Correspondence Address: King & Spalding LLP, 401 Congress Avenue, Suite 3200, Austin, TX, 78701, US

(21) Appl. No.: 12/838,613

(22) Filed: Jul. 19, 2010

(30) Foreign Application Priority Data
Jul. 17, 2009 (DE) 20 2009 009 800.1

(51) Int. Cl. B26F 1/10; B26F 1/14

(52) U.S. Cl. 83/347; 83/689

(57) ABSTRACT

In a device (10) for producing a hole (62) in a sheet-shaped material (60) with a hole tool (20) and a die plate (30), the hole tool (20) is arranged at a first element (40) rotating about a first axis (A1) and the die plate (30) is arranged at a second element (50) rotating about a second axis (A2). The die plate (30) is manufactured of a hard, wear resistant, reversibly deformable material. Arranged between the second element (50) and the die plate (30) is an elastic layer (32) which has a lesser hardness than the die plate (30).

### CROSS-REFERENCE TO RELATED APPLICATIONS

This application claims priority to German Patent Application No. 20 2009 009 800.1 filed Jul. 17, 2009. The contents of which is incorporated herein by reference in its entirety.

### TECHNICAL FIELD

The invention relates to a device for producing a hole in a sheet-shaped material.

### BACKGROUND

Devices for producing a hole in a sheet-shaped material are known which have at least one hole tool and one die plate, wherein for the punching action the hole tool is inserted into the die plate when the sheet-shaped material is located between the hole tool and the die plate in order to perforate the sheet-shaped material in this manner. As is known, both the hole tool and the die plate are manufactured of metal, for example steel, wherefrom the disadvantage arises that these devices have to be manufactured very precise and elaborate. If the hole tool does not exactly engage with the respective die plate this otherwise results in increased wear.

DE 10 2006 027 009 A1 provides a device for producing a hole in a sheet-shaped material in which the die plate at least at its edge surrounding the hole is made of a softer material than the hole tool, wherein the die plate has edge sections of the softer material narrowing its cross sectional area which are cut off by means of the hole tool during the first-time punching action, which is meant to reduce the wear of the hole tool. However, when the device for producing a hole due to mechanical stress has larger play in the course of time, by cutting off of material of the die plate the holes are adapted, which, however, may lead to less precise punching actions. GB 974 112 discloses a device for producing a hole in a sheet-shaped material comprising a die plate made of a material into which the hole tool may penetrate so that the punched-out elements of the sheet-shaped material are pressed into the die plate during the punching action. However, this has the disadvantage that the die plate has to be replaced frequently.

Known from DE 78 23 385 U1 is a device for punching sheet-shaped material in which the hole tool interacts with a rotating die plate which is made of a wearing material such as rubber or a soft plastic material. The hole tool penetrates the soft die plate, whereby that is subjected to wear and has to be replaced frequently.

Known from U.S. Pat. No. 2,621,741 is a device for punching a sheet-shaped material in which a hole tool interacts with a counter roll. The counter roll is coated with a die plate made of a material which is softer than the hole tool. During the stamping action the hole tool penetrates the soft die plate, whereby that is subjected to a strong wear.

### SUMMARY

According to various embodiments, a device for producing a hole in a sheet-shaped material can be provided that is subjected to only little wear.

According to an embodiment, in a device for producing a hole in a sheet-shaped material comprising a hole tool and a die plate, the hole tool is arranged at a first element rotating about a first axis and the die plate is arranged at a second element rotating about a second axis, the die plate is manufactured of a reversibly deformable material, wherein arranged between the second element and the die plate is an elastic layer which has a lesser hardness than the die plate.

According to a further embodiment, the die plate may have a hardness of 60 to 100 Shore, preferably of 70 to 90 Shore, particularly preferred of at least 80 Shore. According to a further embodiment, the die plate can be manufactured of polyurethane. According to a further embodiment, the layer may have a hardness of 50 to 70 Shore. According to a further embodiment, the hole tool may have a longitudinal axis which in particular is arranged perpendicular toward the first axis. According to a further embodiment, the hole tool may have a circumferential cutting edge at its free end. According to a further embodiment, the hole tool, emanating from its free end, in sections can be formed as a hollow cylinder. According to a further embodiment, the cutting edge can be formed by means of beveling the free end of the wall of the hollow cylinder inwardly. According to a further embodiment, the cutting edge may have an inside face which corresponds to a lateral area of a truncated cone, wherein the truncated cone has a longitudinal axis which either is identical to the longitudinal axis of the hole tool or is arranged inclined by an angle toward the longitudinal axis of the hole tool. According to a further embodiment, the cutting edge may lie in a plane which is arranged inclined by an angle toward the perpendicular toward the longitudinal axis of the hole tool. According to a further embodiment, the cutting edge may have a wave cutting.

According to a further embodiment, the wave cutting may have 5 to 12 teeth, preferably 7 to 9 teeth, which preferably are arranged uniformly distributed across the outer circumference of the hole tool. According to a further embodiment, the hole tool can be manufactured of metal, in particular hard metal, in particular steel. According to a further embodiment, the first element can be actuated by means of a motor. According to a further embodiment, the second element can be actuated by means of a motor. According to a further embodiment, the first axis and the second axis can be arranged in parallel to each other. According to a further embodiment, the ratio of the outside radii of the first element and of the second element may correspond to the ratio of two prime numbers. According to a further embodiment, the second element can be arranged movable in the direction of the second axis. According to a further embodiment, the first element and the second element can be arranged spaced from each other such that the distance between the first axis and the second axis at least corresponds to the sum of outside radius of the first element, outside radius of the second element and twice the height of the sheet-shaped material.

### BRIEF DESCRIPTION OF THE DRAWINGS

The invention is described in detail with the help of the following Figures.

FIG. 1 shows a schematic view of an exemplary embodiment of a device for producing a hole in a sheet-shaped material including a drive mechanism and a control for moving the sheet-shaped material,

FIG. 2 shows the device for producing a hole in a sheet-shaped material according to FIG. 1,

FIG. 3a shows a frontal view onto the device according to FIG. 2,

FIG. 3b shows a frontal view comprising a device for an automatic lateral displacement during the rotation of the die plate roll,

FIG. 4a shows an enlarged cut-out view of the device according to FIG. 2 with the hole tool in a first position,

FIG. 4b shows the device according to FIG. 4a with the hole tool in a second position,

FIG. 4c shows an enlarged cut-out view derived from FIG. 4b,

FIG. 4d shows a view corresponding to FIG. 4c comprising another embodiment of the hole tool,

FIG. 5 shows a longitudinal cut through an exemplary embodiment of a hole tool,

FIG. 6 shows a longitudinal cut through a further exemplary embodiment of a hole tool,

FIG. 7 shows the hole tool according to FIG. 6 comprising punched-out elements of the sheet-shaped material located therein,

FIG. 8 shows a side view of an exemplary embodiment of a hole tool,

FIG. 9 shows a cross-section through the hole tool according to FIG. 8, and

FIG. 10 shows a longitudinal cut through the exemplary embodiment of a hole tool according to FIG. 8.

### DETAILED DESCRIPTION

In the device according to various embodiments for producing a hole in a sheet-shaped material comprising a hole tool and a die plate, the hole tool is arranged at a first element rotating about a first axis and the die plate is arranged at a second element rotating about a second axis, and the die plate is manufactured of a reversibly deformable material, wherein between the second element and the die plate a layer is arranged which has a lesser hardness than the die plate in order to allow for the desired elastic yielding of the harder die plate. As a synonym for the term “reversibly deformable” also the term “elastic” may be used. The device according to various embodiments thus has the advantage that the hole tool does not penetrate the die plate upon each stamping action but is pressed against the reversibly deformable material so that the hole tool and the die plate barely are subjected to wear. On the other hand the reversibly deformable material has the advantage that the punched-out elements of the sheet-shaped material do not stay in the reversibly deformable material but are ejected, either directly or at first are pressed into the hole tool from which they drop out or if necessary may be pushed out, so that the die plate is not contaminated by the punched-out elements of the sheet-shaped material.

For example, the die plate may be manufactured of a reversibly deformable hard material, i.e. an elastic material of high resistance to wear. The hard die plate as a counter surface for the hole tool allows for a reliable stamping action. Due to its hard material properties the die plate thus is only subjected to a minimal wear. The softer elastic layer arranged below the die plate thereby allows for the elastic yielding of the die plate under the impact of the stamping tool. Thus it is feasible that the rotating stamping tool and the rotating hard die plate may pass each other without the stamping tool penetrating the hard surface of the die plate and that a wear of the die plate is caused.

Preferably, the die plate may have a hardness of 60 to 100 Shore, preferred of 70 to 90 Shore, particularly preferred of at least 80 Shore in order to have sufficient stability and to keep the wear of the die plate at a minimum also during multiple stampings of the hole tool. Particularly preferred, the die plate may be manufactured of polyurethane. According to an embodiment, the layer arranged between the second element and the die plate has a hardness of 50 to 70 Shore.

Preferably, the hole tool may have a longitudinal axis which in particular is arranged perpendicular toward the first axis. Thus, by rotating the first element about the first axis, by means of the hole tool a hole may be stamped in a simple manner into the sheet-shaped material when this is located between the hole tool and the die plate.

Particularly preferred the hole tool at its free end may have a circumferential cutting edge for punching the hole into the sheet-shaped material.

Preferably, emanating from its free end the hole tool in sections can be formed as a hollow cylinder in order to provide a particularly simple construction of the hole tool in this manner and in particular to be able to allow for the circumferential cutting edge in a simple manner.

Particularly preferred the cutting edge can be formed by means of a beveling of the free end of the wall of the hollow cylinder inwardly. In this manner a sharp cutting edge results which allows for a precise cut.

According to an embodiment, the cutting edge has an inside face which matches a lateral area of a truncated cone, wherein the truncated cone has a longitudinal axis which either is identical to the longitudinal axis of the hole tool or is located inclined by an angle toward the longitudinal axis of the hole tool. In this manner, the cutting edge may be ground in simple form, wherein the centrical grinding allows for a rotationally symmetric embodiment of the hole tool and the grinding carried out in an angle toward the longitudinal axis of the hole tool, for example in an angle of 1° to 5°, particularly preferred in an angle of about 3°, allows for that upon a first contact of the hole tool with the die plate due to the angle a less deep penetration of the leading portion of the hole tool is effected, upon the hole tool leaving the die plate the ejection of the punched-out element of the sheet-shaped material is promoted due to the angle, so that the punched-out elements of the sheet-shaped material immediately may drop out of the hole tool without an additional ejecting from the hole tool being required.

Preferably, the cutting edge can be located in a plane which is arranged inclined by an angle toward the longitudinal axis of the hole tool which also promotes ejecting the element punched-out from the sheet-shaped material out of the hole tool.

According to an embodiment, the cutting edge has a wave cutting which has the advantage that upon the punching action at first the outermost peaks of the wave cutting come into engagement with the sheet-shaped material and subsequently a cutting action along the edges of the wave cutting is carried out, which on the one hand allows for a sharp cutting edge and on the other hand prevents against a wear of the hole tool.

The wave cutting may have a plurality of teeth. Generally, the number of teeth is unlimited and thus, it may comprise at least one tooth or more teeth. Preferably, the wave cutting may have 5 to 12 teeth, particularly preferred 7 to 9 which preferably are arranged uniformly distributed across the outer circumference of the hole tool.

Advantageously, the hole tool can be manufactured of metal, in particular hard metal, in particular steel.

Preferred, the first element can be actuated by means of a motor in order to carry out the punching action in an automatic manner.

In one embodiment, the second element may be formed without a drive mechanism, wherein either the second element is set into rotation by means of friction during the passing through of the sheet-shaped material or upon engagement with the die plate of the second element the hole tool entrains this second element and sets it into rotation in this manner. In an alternative embodiment the second element may be actuated by means of a motor.

A particularly simple geometric configuration is produced when the first axis and the second axis are arranged in parallel to each other. In order to avoid that the hole tool engages in the same location of the die plate upon each stamping action the ratio of the outside radii of the first element and of the second element preferably may correspond to the ratio of two prime numbers in order to distribute the engagement locations of the hole tool into the die plate uniformly across the outer circumference of the die plate in this manner. Thereby, the wear of the die plate is reduced additionally.

In order to yet further reduce the wear of the die plate, preferably the second element can be arranged slidably in the direction of the second axis so that after a plurality of punching actions the second element is arranged in a shifted manner with respect to the first element so that the hole tool subsequently engages with an area of the die plate until then not yet stressed. For example, an automatic shifting results from a cyclic lateral displacement by means of an excentric device. Therefore, the device comprises an excentric device for automatic lateral displacement of the second element.

In an embodiment, the first and the second element are located spaced from each other such that the distance between the first axis and the second axis corresponds with at least the sum of outside radius of the first element, outside radius of the second element and twice the height of the sheet-shaped material, whereby it is allowed for that the second element does not require an own drive mechanism and the sheet-shaped material may be moved through the gap between the first element and the second element without being restrained by the friction with the second element or to entrain the second element by means of friction.

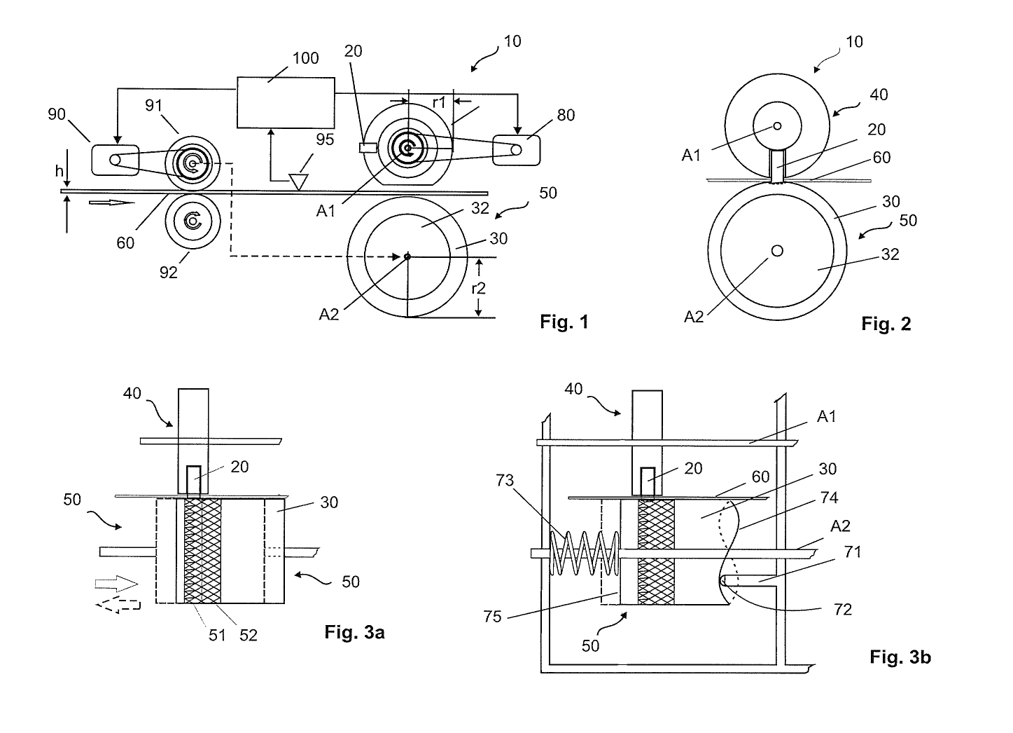

FIGS. 1, 2 and 3 schematically show a device 10 for producing a hole 62 in a sheet-shaped material 60 which has a first element 40 comprising an outside radius r1 arranged rotatable about a first axis Al and a second element 50 comprising an outside radius r2 arranged rotatable about a second axis A2 between which the sheet-shaped material 60 is passed through. The sheet-shaped material 60 has a height h.

The actuation of the sheet-shaped material 60 is carried out by means of two drive rolls 91, 92 which are arranged in the direction of movement or axially shifted with respect to the first element 40 and the second element 50 and wherein the drive roll 91 is actuated by means of a motor 90. A control unit 100 controls the motor 90. A sensor 95 may check the position of the sheet-shaped material 60 and may forward that to the control unit 100 so that the drive mechanism of the sheet-shaped material 60 may be controlled depending on position.

At least the first element 40 is actuated by means of a motor 80. The second element 50 either may be actuated by means of a further motor or may be entrained upon movement of the first element by means of the friction with the sheet-shaped material 60 or simply may be entrained during the stamping action described in the following by means of a hole tool 20 located at the first element upon engagement of the hole tool 20 with the second element 50. Depending thereof the distance between the first axis A1 and the second axis A2 is chosen such that either the sheet-shaped material 60 lies against both the first element 10 and the second element 50 or the distance is greater than the sum of an outside radius r1 of the first element 40, an outside radius r2 of the second element 50 and twice the height h of the sheet-shaped material 60.

FIG. 2 shows an enlarged view of device 10, wherein according to FIG. 1 the cross-section of the first element 40 is D-shaped while according to FIG. 2 the first element 40 has a round cross-section which can be considered insignificant for the various embodiments and simply influences the movement of the sheet-shaped material 60, since by means of the D-shaped section of the first element 40 for example a movement of the sheet-shaped material 60 in the feeding direction may be delayed or avoided.

The second element 50 preferably may have a cylindric core 54 of a hard material, for example steel, ceramic or a respective plastic material. A die plate 30 may be arranged directly on the core 54. In a further embodiment, on the core 54 at first a layer 32 is arranged on which the die plate 30 is located.

The die plate 30 is manufactured of a reversibly deformable hard material, i.e. an elastic material of high resistance to wear. In particular, the die plate 30 has a hardness of 60 to 100 Shore, in particular of 70 to 90 Shore, preferably of at least 80 Shore. For example, the die plate 30 may be manufactured of polyurethane.

The layer 32 consists of a softer elastic material comprising a lesser hardness than the die plate 30, for example a hardness of 50 to 70 Shore.

The design of the die plate 30 using a hard reversibly deformable material causes that the die plate 30 is subjected to lesser wear. Furthermore, the soft elastic layer 32 causes that the die plate 30 made of the hard material may yield elastically so that no recess has to be manufactured with which the hole tool 20 engages and which therefore would have to be manufactured with high precision.

The die plate 30 thus forms the hard wear resistant surface of the counter surface for the hole tool 20 while the yieldable deformable layer 32 causes the elastic counter pressure for the hole tool 20.

In order that during producing the holes 62 in the sheet-shaped material 60 the hole tool 20 not always engages at the same location of the die plate 30 and thus the wear of the die plate 30 is reduced, on the one hand, the outside radius of the die plate 30 may be chosen as large as possible, in particular larger than the outside radius of the first element 40. Furthermore, it contributes in reducing the wear of the die plate 30 when the ratio of the outside radii of the first element 40 and of the second element 50 corresponds to the ratio of two prime numbers so that the engagement positions of the hole tool 20 with the die plate 30 are distributed uniformly across the outer circumference of the die plate 30. Furthermore, it is feasible, as shown in FIG. 3, to arrange the second element 50 in a manner sliding along its second axis A2 so that for a first time period the hole tool 20 engages with a first axial region 51 and after a displacement of the second element 50 in the direction of the second axis A2 the hole tool 20 engages with a second axial region 52 and depending on the width of the second element 50 with further axial regions.

Depicted in FIG. 3b is a device for an automatic axial displacement of the second element 50. By means of a S-shaped implementation of the one side face 74 of the second element, a pressure spring 73 on the second side face 75 of the second element and a deflection pin 71, for example fixedly mounted at the housing, with a rotating roll or a rotating ball 72 a cyclic axial displacement of the areas 51 and 52 used as a die plate is achieved.

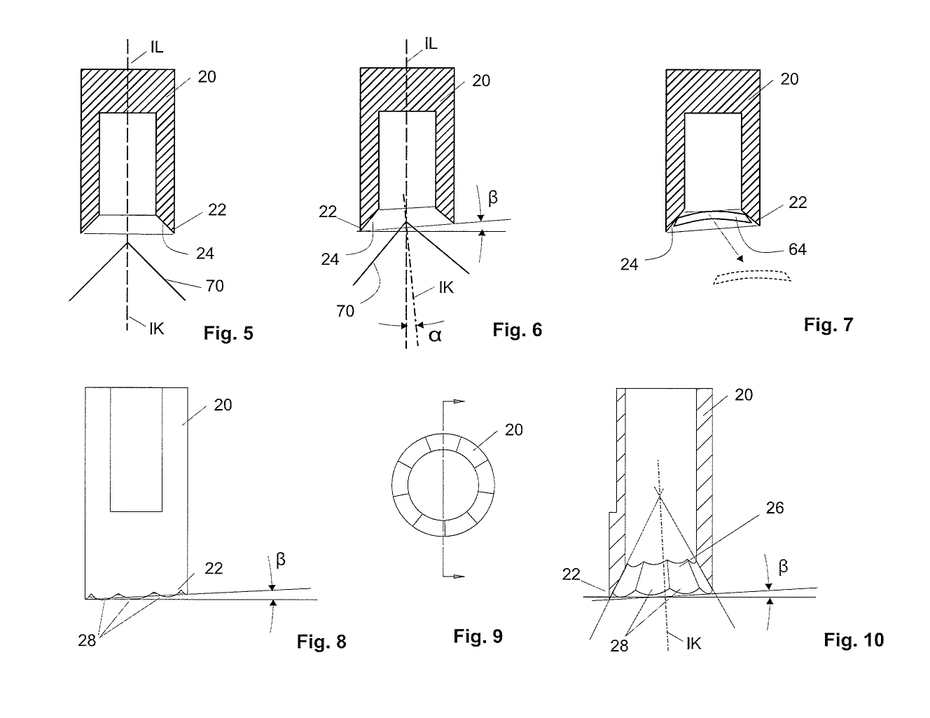

Possible embodiments of the hole tool 20 are described by means of FIGS. 5 to 10. The hole tool 20 has a longitudinal axis 1L and, as a general rule, is formed cylindrically. The cross-section of the hole tool 20 may be round, but also triangular, rectangular, oval or may comprise an ornamental characteristic such as for example star-shaped or the like in order to be able to produce holes 62 of arbitrary cross-section. The hole tool 20 is arranged in the first element 40 with one end so that the other end forms a free end 21. As a general rule, the hole tool 20 is mounted on the first element 40 such that its longitudinal axis 1L is arranged substantially perpendicular toward the first axis A1.

Arranged at the free end 21 of the hole tool 20 is a circumferential cutting edge 22. For example, the cutting edge 22 may be formed in that a chamfer is ground crosswise to the longitudinal axis 1L of the hole tool 20. However, preferred in combination with the reversibly deformable die plate 30 can be cutting edges 22 which substantially lie in one plane, wherein the plane may be arranged perpendicular toward the longitudinal axis 1L of the hole tool 20 (see FIG. 5) or inclined in an angle toward the perpendicular of the longitudinal axis 1L of the hole tool 20 (see FIGS. 6 and 7). With an inclination of the cutting edge 22 in an angle toward the perpendicular of the longitudinal axis 1L, upon a punching action in particular the leading portion of the cutting edge 22 is pressed into the die plate 30 less deep than the trailing portion of the cutting edge 22.

Emanating from its free end 21 the hole tool 20 may in sections be formed as a hollow cylinder. Thus, the cutting edge 22 is formed in particular by beveling the wall of the hollow cylinders inwardly.

The cutting edge 22 in particular has an inside face 24 which is part of the lateral area of a cone, in particular the lateral area of a truncated cone, wherein the latter in particular is the case when the hole tool 20, emanating from its free end 21, at least in sections is formed as a hollow cylinder. The cutting edge 22 in particular is ground by means of a grinding cone 70 having a longitudinal axis 1K. When introducing the grinding cone 70 such that the longitudinal axis 1K is identical with the longitudinal axis 1L of the hole tool 20 a centrical, rotationally symmetric grinding results comprising a cutting edge 22 located in a plane proceeding perpendicularly toward the longitudinal axis 1L of the hole tool 20 (see FIG. 5). When the grinding cone 70 is introduced inclined in an angle a toward the longitudinal axis 1L of the hole tool 20 also an inclination of the plane in which the cutting edge 22 is located results toward the perpendicular of the longitudinal axis 1L by an angle β, wherein α and β are identical (see FIG. 6). The angles α or β in particular may be 1° to 5°, for example 3°.

Particularly preferred, ground into the inside face 24 of the cutting edge 22 can be a wave cutting 26 comprising several teeth 28 (see FIGS. 8 to 10). The teeth 28 preferably can be arranged in uniform distribution across the outer circumference of the hole tool 20. For example, the wave cutting 26 has 5 to 12 teeth, preferably 7 to 9 teeth 28. The teeth 28 are produced by means of grinding cones comprising smaller angles of aperture than the angle of aperture of the grinding cone 70.

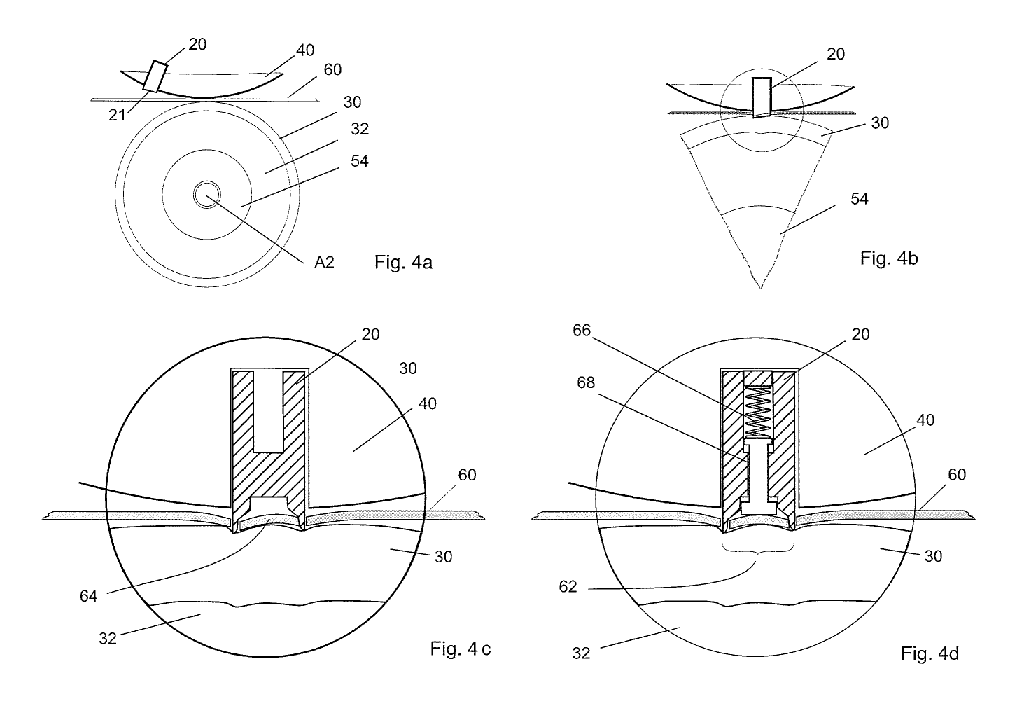

The stamping action is described by means of FIGS. 4a to 4c. Between the first element 40 and the second element 50 the sheet-shaped material 60 is moved. The first element 40 is rotated about the first axis A1, wherein in FIG. 4a the position of the hole tool 20 at the first element 40 is illustrated prior to the punching action. Upon further rotation of the first element 40 the hole tool 20 engages with the sheet-shaped material 60 (see FIGS. 4b and 4c), wherein in particular due to the inclination of the cutting edge 22 with angle β toward the perpendicular crosswise to the longitudinal axis 1L of the hole tool 20 the leading portion of the cutting edge 22 at first engages less deep with the sheet-shaped material 60 than the trailing portion of the cutting edge 22. In particular when a hole tool comprising a wave cutting 26 in the cutting edge 22 is used, furthermore at first the peaks of the teeth 28 of the wave cutting 26 engage with the sheet-shaped material 60, wherein upon further rotation of the hole tool 20 emanating from the peaks of the wave cutting 26 cuts along the outer circumference of the hole tool 20 are carried out which result in a complete stamping of a punched-out element 64 after passage of the hole tool 20. Due to the reversibly deformable die plate 30 the hole tool 20 engages with the die plate 30, wherein, however, the punched-out element 64 is pressed into the free end 21 of the hole tool 20 and in particular does not stay in the die plate 30. The cutting edge 22 comprising an inside face 24 bends the punched-out element 64 approximately bowl-shaped, in particular when using a circumferential cutting edge 22. However, the face 24 of the cutting edge 22 jolts the punched-out element 64 such that as soon as the hole tool 20 no longer is in engagement with the die plate 30 the punched-out element 64 bounces out of the free end 21 of the hole tool 20 without additional ejecting tools being required (see FIG. 7). In this manner it is ensured on the one hand that the punched-out element 64 does not stay in the device 10 and thus no additional measures are necessary to remove the punched-out elements 64 from the device 10. In a variant illustrated in FIG. 4d, however, also an ejector pin 68 loaded by a pressure spring 66 may in addition be supported in the hole tool 20 in an axially movable manner which additionally ensures that the punched-out element 64 reliably is removed from the hole tool 20. Furthermore, the hole tool 20 is subjected to only little wear since it engages with a reversibly deformable die plate 30 and thus only is exposed to low shearing forces. Due to its hardness and the reversible deformability, i.e. its elasticity, the die plate 30 also only is subjected to little wear. As in particular indicated by the enlarged view of FIG. 4c these advantages are yet favored in that the hard die plate 30, by means of an elastic deformation of the softer layer 32, may marginally accommodate the pressure of the hole tool 20. Thus the wear of the die plate 30 is reduced, wherein the elasticity of the layer 32 maintains the counter pressure for the hole tool 20. In that different measures may be taken in order to bring the hole tool 20 in engagement with different areas of the die plate 30 located circumferentially on the second element 50, the wear of the second element 50 and of the die plate 30 is further reduced so that in this manner a low-cost device 10 only subjected to little wear is provided.

Arranged at the first element 40 merely may be a hole tool 20 whose rotation is controlled such that the desired number of holes 62 is produced in the sheet-shaped material 60 by means of a single hole tool 20, for example punched holes for a DIN A4 paper or for US formats. Alternatively, also several hole tools may be arranged at the first element 40 in a respective angular distance in order to produce the desired punching in the sheet-shaped material 60, for example by means of one revolution of the first element 40.

### REFERENCE NUMERALS

10 device
20 hole tool
21 free end
22 cutting edge
24 face
26 wave cutting
28 tooth
30 die plate
32 layer
40 first element
50 second element
51 first axial area
52 second axial area
54 core
60 sheet-shaped material
62 hole
64 punched-out element
66 pressure spring
68 ejector pin
70 grinding cone
71 deflection pin
72 rotating contact roll
73 pressure spring
74 S-shaped side wall
75 flat side wall
80 motor
90 motor
91 drive roll
92 drive roll
95 sensor
100 control unit
1L longitudinal axis
1K longitudinal axis
A1 first axis
A2 second axis
r1 outside radius
r2 outside radius
h height
α angle
β angle

What is claimed is:

1. A device for producing a hole in a sheet-shaped material comprising a hole tool and a die plate, wherein the hole tool is arranged at a first element rotating about a first axis and the die plate is arranged at a second element rotating about a second axis, the die plate is manufactured of a reversibly deformable material, an elastic layer is arranged between the second element and the die plate and wherein the elastic layer has a lesser hardness than the die plate.

2. The device according to claim 1, wherein the die plate has a hardness of 60 to 100 Shore, or of 70 to 90 Shore.

3. The device according to claim 1, wherein the die plate has a hardness of at least 80 Shore.

4. The device according to claim 1, wherein the die plate is manufactured of polyurethane.

5. The device according to claim 1, wherein the layer has a hardness of 50 to 70 Shore.

6. The device according to claim 5, wherein the hole tool has a longitudinal axis which is arranged perpendicular toward the first axis.

7. The device according to claim 1, wherein the hole tool has a circumferential cutting edge at its free end.

8. The device according to claim 1, wherein the hole tool, emanating from its free end, is formed in sections as a hollow cylinder.

9. The device according to claim 7, wherein the cutting edge is formed by means of beveling the free end of the wall of the hollow cylinder inwardly.

10. The device according to claim 7, wherein the cutting edge has an inside face which corresponds to a lateral area of a truncated cone, wherein the truncated cone has a longitudinal axis which either is identical to the longitudinal axis of the hole tool or is arranged inclined by an angle toward the longitudinal axis of the hole tool.

11. The device according to claim 7, wherein the cutting edge lies in a plane which is arranged inclined by an angle toward the perpendicular toward the longitudinal axis of the hole tool.

12. The device according to claim 7, wherein the cutting edge has a wave cutting.

13. The device according to claim 12, wherein the wave cutting has a plurality of teeth, which are arranged uniformly distributed across the outer circumference of the hole tool.

14. The device according to claim 12, wherein the wave cutting has 5 to 12 teeth, or 7 to 9 teeth, which are arranged uniformly distributed across the outer circumference of the hole tool.

15. The device according to claim 1, wherein the hole tool is manufactured of metal, or hard metal or steel.

16. The device according to claim 1, wherein the first element is actuated by means of a motor.

17. The device according to claim 1, wherein the second element is actuated by means of a motor.

18. The device according to claim 1, wherein the first axis and the second axis are arranged in parallel to each other.

19. The device according to claim 1, wherein the ratio of the outside radii of the first element and of the second element corresponds to the ratio of two prime numbers.

20. The device according to claim 1, wherein the second element is arranged movable in the direction of the second axis.

21. The device according to claim 20, wherein the device has an excentric device for automatic displacement of the second element.

22. The device according to claim 1, wherein the first element and the second element are arranged spaced from each other such that the distance between the first axis and the second axis at least corresponds to the sum of outside radius of the first element, outside radius of the second element and twice the height of the sheet-shaped material.

23. The device according to claim 1, wherein the second element has a cylindric core of a hard material, steel, ceramic or plastic material.
